(19) United States
(12) Patent Application Publication
(10) Pub. No.: US 2005/0250510 A1
(43) Pub. Date: Nov. 10, 2005

(54) Reduced performance mode of operation for use as needed by a wireless communication terminal

(76) Inventors: Jorma Kaikkonen, Oulu (FI); Sari Nielsen, Espoo (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/841,230

(22) Filed: May 7, 2004

(51) Int. Cl. H04L 1/00

(52) U.S. Cl. 455/452.2; 455/452.1

(57) ABSTRACT

A wireless communication terminal (10) having a plurality of radio receiver branches (11a-c) all ordinarily for use in receiving a downlink frequency from a radio access network (15), but configured to intermittently tune one or another of the branches (11a-c) to a non-downlink frequency (causing reduced receiver performance in receiving the downlink frequency), but doing so only when expected by the radio access network (15) (or other entity of a wireless communication network with which the wireless communication terminal is in wireless communication).

### TECHNICAL FIELD

The present invention pertains to the field of wireless communication, including e.g. mobile communications terminals for use with one or another kind of cellular communication network, but also including wireless communication via other than cellular communication networks. More particularly, the present invention pertains to wireless communication terminals having multiple radio receiver branches and sometimes using one of the branches for various different measurements, such as inter-frequency or inter-RAT (radio access technology) measurements.

### BACKGROUND ART

New UE (User Equipment) receiver performance requirements for HSDPA (High Speed Downlink Packet Access) that would call for increased performance in receiving a downlink signal from a radio access network (RAN) of a cellular communication network are currently being considered. The new requirements are to be based on assuming the use of multiple radio receiver branches in a UE, providing UE receiver diversity.

Currently a UE must perform inter-frequency and inter-RAT measurements either by using compressed mode (in which while the UE performs the measurements, the RAN slows the rate at which it downlinks to the UE, and then uses a compressed mode downlink to catch up after the UE completes the measurements) or by using an additional receiver dedicated to inter-frequency measurements and/or inter-RAT measurements and potentially also for inter-RAT operations when a WCDMA (Wideband Code Division Multiple Access)/GSM (Global System for Mobile Communications) multimode terminal operates in GSM. There are also various other different measurements a UE sometimes must perform, including measurements for use determining the location of the UE.

Since to meet the increased performance requirements a UE will likely include multiple radio receiver branches (although in principle the requirements could potentially be met in other ways), it would be advantageous to be able to use, from time to time, one of the radio receiver branches in such a UE to perform the various different measurements the UE must perform. However, the UE is not allowed to do so if it means the performance requirements will not be met.

### DISCLOSURE OF THE INVENTION

Accordingly, in a first aspect of the invention, a method is provided for use in communication at a downlink frequency between a wireless communication terminal, having a plurality of radio receiver branches, and a radio access network or other wireless communication terminal, comprising: a step in which the wireless communication terminal tunes at least one of the plurality of radio receiver branches to a non-downlink frequency and so begins operating in a reduced performance mode; and a step of retuning the at least one radio receiver branch to the downlink frequency; wherein the wireless communication terminal signals or otherwise indicates to the radio access network or other wireless communication terminal intermittent use of the reduced performance mode.

In accord with the first aspect of the invention, the method may further comprise: a step in which the wireless communication terminal signals to the radio access network or other wireless communication terminal an indication that the wireless communication terminal uses the reduced performance mode in order to receive the non-downlink frequency.

Also in accord with the first aspect of the invention, the method may further comprise: a step in which the radio access network or other wireless communication terminal receives from the wireless communication terminal an indication that the wireless communication terminal uses the reduced performance mode in order to receive the non-downlink frequency.

Also in accord with the first aspect of the invention, the method may further comprise: a step in which the radio access network or other wireless communication terminal compensates for use of the reduced performance mode by using increased downlink power or by using a more robust radio link during at least some time periods when the wireless communication terminal is expected to use the reduced performance mode.

Also in accord with the first aspect of the invention, the method may further comprise: a step in which the radio access network or other wireless communication terminal signals to the wireless communication terminal an indication of an allowed time period when the wireless communication terminal is authorized to use the reduced performance mode.

In a second aspect of the invention, a computer program product is provided, comprising: a computer readable storage structure embodying computer program code thereon for execution by a computer processor in a wireless communication terminal having a plurality of radio receiver branches ordinarily all used to receive a downlink frequency from a radio access network or other wireless communication terminal, with said computer program code characterized in that it includes instructions for performing a method comprising: a step in which the wireless communication terminal signals to the radio access network or other wireless communication terminal an indication that the wireless communication terminal may use a reduced performance mode in order to receive a non-downlink frequency; and a step in which the wireless communication terminal tunes at least one of the plurality of radio receiver branches to the non-downlink frequency and so begins operating in the reduced performance mode.

In a third aspect of the invention, a computer program product is provided, comprising: a computer readable storage structure embodying computer program code thereon for execution by a computer processor in a component of a radio access network or a downlinking wireless communication terminal configured for providing a downlink signal on a downlink frequency to a wireless communication terminal having a plurality of radio receiver branches ordinarily all used to receive the downlink frequency, with said computer program code characterized in that it includes instructions for performing a method comprising: a step in which the radio access network or downlinking wireless communication terminal receives from the wireless communication terminal an indication that the wireless communication terminal uses a reduced performance mode in order to receive a non-downlink frequency; and a step in which the radio access network or downlinking wireless communication terminal compensates for use of the reduced performance mode by using increased downlink power or by using a more robust radio link during a time period when the wireless communication terminal is using the reduced performance mode.

In a fourth aspect of the invention, a wireless communication terminal is provided, comprising: a plurality of radio receiver branches; and a controller, for tuning the radio receiver branches to a downlink frequency for receiving a downlink signal from a radio access network or other wireless communication terminal; wherein in order to also receive a non-downlink frequency, the controller tunes at least one of the radio receiver branches to the non-downlink frequency and so receives the downlink frequency in a reduced performance mode, and further wherein the wireless communication terminal signals or otherwise indicates to the radio access network or other wireless communication terminal intermittent use of the reduced performance mode.

In accord with the fourth aspect of the invention, the wireless communication terminal may further comprise: means for signalling to the radio access network or other wireless communication terminal an indication that the wireless communication terminal uses the reduced performance mode in order to receive the non-downlink frequency.

Also in accord with the fourth aspect of the invention, the wireless communication terminal may further comprise: means for compensating for the use of the reduced performance mode. Further, the means for compensating for the use of the reduced performance mode may be based on a request for increased downlink power, or may be based on using a channel quality indicator report to indicate a lower channel quality.

Also in accord with the fourth aspect of the invention, the wireless communication terminal may further comprise: means for receiving from the radio access network or other wireless communication terminal an indication of an allowed time period when the wireless communication terminal is authorized to use the reduced performance mode; and the controller may tune the at least one radio receiver branch to the non-downlink frequency only during the allowed time period.

Also in accord with the fourth aspect of the invention, the controller may tune the at least one radio receiver branch to the non-downlink frequency at a time decided on autonomously by the wireless communication terminal, such as at a time based on observed received signal quality.

Also in accord with the fourth aspect of the invention, the non-downlink frequency may be a frequency associated with inter-frequency or inter-radio-access-technology measurements, or may be a frequency used for location measurements, or may be any frequency, including another downlink frequency, other than the downlink frequency to which the other radio receiver branches are tuned.

In a fifth aspect of the invention, a radio access network is provided, comprising: means for receiving from a wireless communication terminal an indication that the wireless communication terminal uses a reduced performance mode in receiving a downlink frequency from the radio access network or other wireless communication terminal in order to also receive a non-downlink frequency; and means for determining when the wireless communication terminal is using or is authorized to use the reduced performance mode.

In accord with the fifth aspect of the invention, the radio access network may further comprise: means for accommodating the reduced performance mode by using increased downlink power or by using a more robust radio link during at least some time periods when the wireless communication terminal is expected to use the reduced performance mode.

Also in accord with the fifth aspect of the invention, the radio access network may further comprise: means for signaling to the wireless communication terminal an indication of an allowed time period when the wireless communication terminal is authorized to use the reduced performance mode.

In a sixth aspect of the invention, a wireless communication network is provided, including a radio access network according to the fifth aspect of the invention, and including a wireless communication terminal configured for wireless communication with the wireless communication network via the radio access network and according to the fourth aspect of the invention.

In accord with the sixth aspect of the invention, the wireless communication network may be a cellular communication network. Also, the wireless communication terminal may be a mobile communication terminal.

### BRIEF DESCRIPTION OF THE DRWINGS

The above and other objects, features and advantages of the invention will become apparent from a consideration of the subsequent detailed description presented in connection with accompanying drawings, in which:

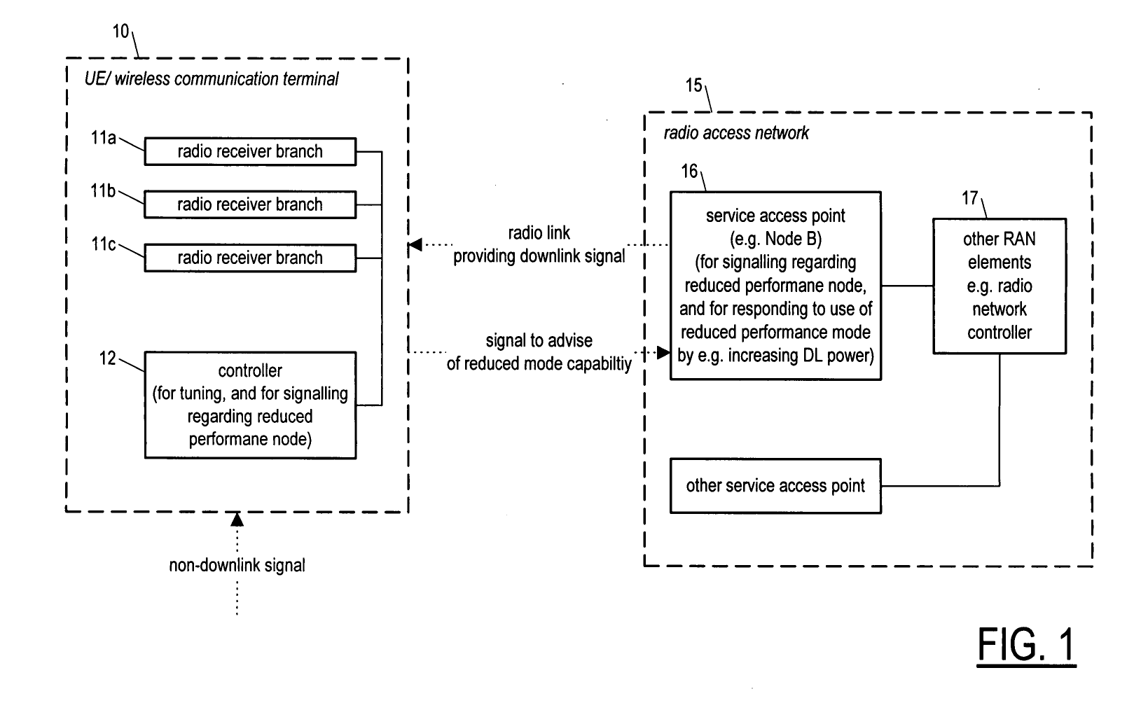

FIG. 1 is a block diagram of a UE and a RAN, both according to the invention.

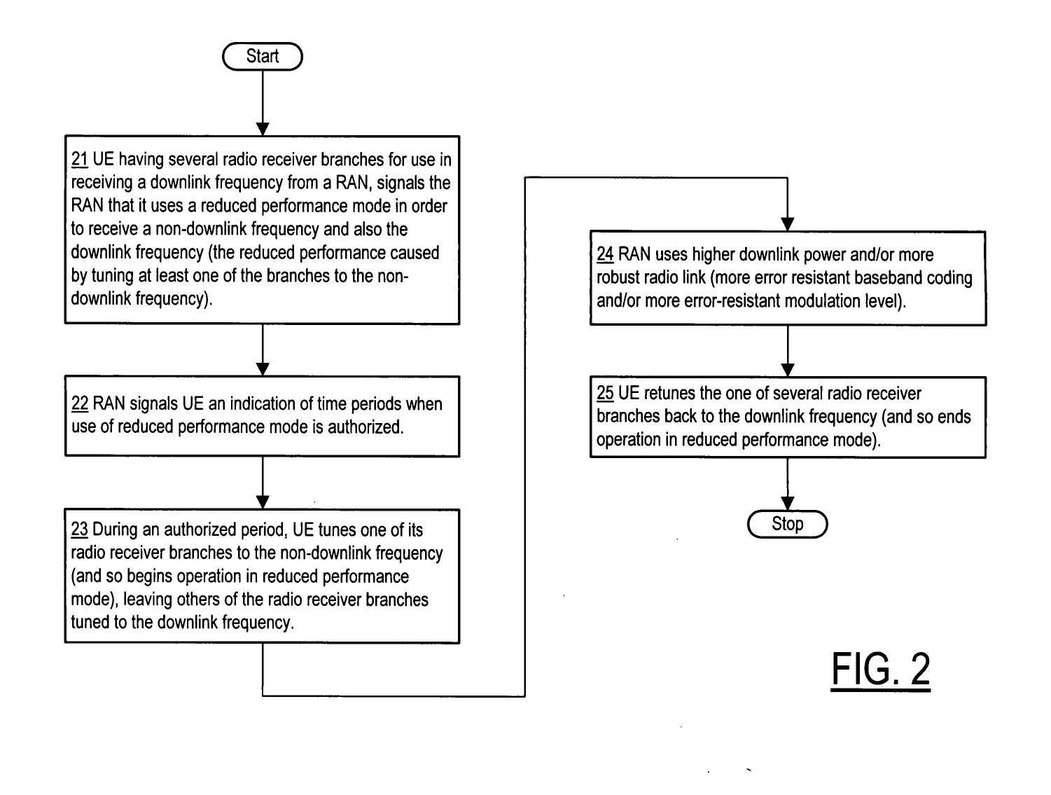

FIG. 2 is a flow chart illustrating operation of a UE and a RAN, both according to the invention.

### DETAILED DESCRIPTION OF THE INVENTION

The invention is here described in terms of a UE having a plurality of radio receiver branches. A UE is to be understood here as any kind of wireless communication terminal, i.e. not necessarily a mobile communication terminal for use in cellular communication, but of course encompassing such a communication terminal. The term UE in particular is intended to also encompass equipment configured for short-range wireless communication, such as according to Bluetooth.

According to the invention, in the case a UE fulfils receiver performance requirements by having multiple radio receiver branches, while ordinarily using all radio receiver branches to provide receiver diversity in receiving a downlink signal from a RAN, the UE uses one or more of the branches momentarily to perform the required inter-frequency and inter-RAT measurements or other kinds of measurement—i.e. for receiving a non-downlink signal—while keeping the other radio receiver branches tuned to the original downlink signal. However, doing so—i.e. operating in reduced performance mode—means that the UE is not necessarily able to fulfil the receiver performance requirements while receiving the non-downlink signal. Hence, the invention includes methods for momentarily allowing the performance degradation, i.e. methods by which the RAN knows when to expect that the UE might operate in reduced performance mode.

According further to the invention, then, the UE signals to the RAN that it sometimes uses a reduced performance mode, i.e. that it is configured to, from time to time, momentarily use one or more of its radio receiver branches for other than receiving the downlink signal from the RAN. Such signalling can be done, e.g., each time the UE is turned on. That the UE is configured to use reduced performance mode could be signaled to the RAN using a predetermined capability-signalling bit or bits. The reduced mode capability could even be signaled as being used specifically for receiving only some non-downlink frequencies. For example, a UE might have a dedicated receiver for inter-RAT or for inter-frequency measurements but not for both, and so would use reduced performance mode only for the one for which it does not have a dedicated receiver, and the signaling to the RAN would indicate such restricted use of the reduced performance mode.

When the RAN requests that a UE make measurements (such as inter-RAT or for inter-frequency measurements) requiring that a non-downlink frequency be received, the UE would be allowed to reduce its receiver performance in order to receive the non-downlink frequency, and the RAN would, according to the invention, anticipate the UE doing so (because it is aware that the UE has the capability of doing so, or, in other words, is configured to do so). Alternatively, the RAN could also indicate via a dedicated signalling channel or other mechanism a time period (or a number of time periods) during which the UE is authorized to use reduced performance mode, which would allow the UE to receive non-downlink frequencies not only for use in different requested measurements, but also for use in measurements the UE makes autonomously (including those made at the prompting of a user). In such an embodiment, regardless of when the UE might receive a measurement control message calling e.g. for inter-frequency and/or inter-RAT measurements, the UE would perform the measurements only during the time period (or one of the time periods) during which it is authorized to use its reduced performance mode.

It some embodiments according to the invention, instead of indicating a particular window/time period during which reduced mode operation is authorized (or a list of such time periods), the UE decides when to do so autonomously. For example, in case of receiving a request to perform an inter-frequency or inter-RAT measurement, the UE (and in particular the controller or some other element, not shown) can autonomously schedule when to perform the measurement, and so, in effect, autonomously schedule the use of reduced performance mode, since it will use reduced performance mode to make the measurement. As explained above, the RAN would know that the UE occasionally uses reduced performance mode, and so when the network requests the UE to perform a measurement for which the UE needs to use reduced mode, the RAN can assume that the UE will do so, whenever the UE does actually perform the measurement.

The RAN (and in particular, e.g. a service access point of same, such as a NodeB or base station transceiver, or a base station controller) could take the reduced performance of the UE into account by reserving more downlink power for the UE (making it possible for the UE to still receive the downlink signal adequately, even in its reduced performance mode), or in case of packet scheduling (HSDPA) allocate a TFRC (Transport Format Resource Combination) that is more likely to be received correctly by the UE, i.e. one that e.g. uses more error resistant coding and/or more error-resistant modulation.

The invention however does not require such an accommodating by the RAN, since a UE's own power control mechanism (closed and outer loop power control) for DPCH (dedicated physical channel) would be able to require more power on the downlink based on the observed signal quality, and in case of HSDPA, the CQI (channel quality indicator) reports by the UE to the RAN would follow the actual receiver performance of the UE. Hence, an HSDPA UE fulfilling the increased receiver performance requirements would likely report lower CQI's during reduced mode, and the RAN—and more particularly, a service access point—can then take into account the actual performance of the UE in the packet scheduler of the service access point. On the other hand, in the signal quality estimation of DPCH the UE needs to consider its actual receiver performance during the reduced mode as well, in order to make the power control work properly. Slightly higher downlink power might be required for DPCH at the start of reduced mode in order to maintain the service quality, since it takes a moment before the UE power control mechanism to compensate a performance difference between normal mode and reduced mode. (Note that UE performance according to the invention would never be worse than single receiver performance as currently specified.)

Referring now to FIG. 1, a UE 10 according to the invention is shown as including a plurality of radio receiver branches 11a 11b 11c tuned under the control of a controller 12 for receiving from a RAN 15 a downlink signal at a downlink frequency. Ordinarily, all of the radio receiver branches are so tuned, so as to each receive the downlink frequency and so allow for the use of receiver diversity in receiving the downlink signal, thus providing increased performance over what would be possible without using receiver diversity. From time to time, according to the invention, the controller 12 tunes one or another of the radio receiver branches to a non-downlink frequency, and so causes the UE to operate in reduced performance mode. According further to the invention, the UE 10 signals the RAN—and more particularly a service access point 16 (a Node B in some networks)—so as to inform the RAN that the UE is configured to be able to use (from time to time) reduced performance mode for receiving a non-downlink signal. The signaling can be performed by the controller 12, or can be performed by other elements (not shown) of the UE 10.

Referring now to FIG. 2 (and also to FIG. 1), a method is shown according to the invention including a first step 21 in which the UE 10 signals the RAN 15 (using e.g. the signaling of predetermined bits, described above) that the UE uses a reduced performance mode in order to receive a non-downlink frequency and also the downlink frequency, i.e. that it is adapted to be able to do so. As explained above, the UE will do so only as anticipated by the RAN, i.e. only for time periods the RAN knows are time periods during which the UE might use reduced performance mode. In a next step 22, in one embodiment as described above, the RAN signals the UE an indication of time periods when use of reduced performance mode is authorized (but not necessarily required), and so the RAN is thus able to anticipate when the UE might use reduced performance mode. The controller 12 of the UE (or another UE element) receives the authorized time periods. The service access point 16 or some higher level network entity 17 such as a radio network controller can decide on what time periods are to be authorized; the service access point of course then communicates the authorized time periods to the UE10. If the service access point 16 decides on the authorized time periods, it can then communicate the authorized time periods to a higher level network element so as to make the information available to other service access points. Thus, the RAN 15 includes one or another element that can determine when the UE is using or is authorized to use reduced mode by referring to e.g. a stored copy of the list of authorized time periods sent to the UE.

In a next step 23, during an authorized period, the controller of the UE tunes one of its radio receiver branches to the non-downlink frequency (and so begins operation in reduced performance mode), leaving others of the radio receiver branches tuned to the downlink frequency. In a next step 24, the RAN—and in particular the service access point 16, possibly under the direction of a higher-level network entity 17—uses a higher downlink power and/or more robust radio link (more error resistant baseband coding and/or more error-resistant modulation level). As explained above, other mechanisms are also possible by which the use of reduced performance mode by the UE can be taken into account (such as e.g. the power control procedure used by the UE and Node Bs in a third-generation cellular network). The controller 12 or other elements (not shown) of the UE 10 can compensate for the user of reduced mode. In a next step 25, the UE retunes the non-downlink tuned radio receiver branch back to the downlink frequency, and so ends operation in reduced performance mode.

It should be noted that in for DPCH, a UE that uses reduced performance mode should take the reduced performance mode into account in its signal quality estimation for power control. Note that typically this will be directly visible in the requested downlink power (via transmit power control commands) (for example due to a measured SIR (signal to interference ratio) in the receiver having a worse value than when not using reduced performance mode) but some delay may be caused in providing the SIR estimate used in the downlink power control unless the UE reports an anticipated worse SIR value based on its knowing what the SIR value is likely to be once it starts using reduced mode.

For HSDPA, as already mentioned, the UE should take the reduced mode performance into account in its CQI reports to the network. Note that typically the reduced performance will be directly visible in the reported CQI (for example due to worse measured SIR in the receiver) but there may be some delay for example due to SIR filtering, unless the UE anticipates that there may be a delay, as described above for DPCH.

Note also that a UE could schedule its inter-frequency and/or inter-RAT measurement (or tuning a radio receiver branch to a non-downlink frequency for any other purpose, including location measurements) based on observed received signal quality. Doing so would reduce the negative impact of tuning a receiver to a non-downlink frequency.

The invention is of use with a UE configured for any kind of wireless communication, including any kind of cellular communication or even short-range wireless communication (such as according to Bluetooth). The UE in particular, can be a mobile communication terminal configured for use with one or more cellular communication networks. In case of communication by other than a cellular communication network, the radio access network 15 (FIG. 1) can be any network entity that communicates wirelessly and directly with the UE 10; in particular it can be another UE/ wireless communication terminal. Thus, in case of short-range wireless communication, the UE 10 may be any equipment including e.g. Bluetooth functionality (e.g. a laptop computer), and the radio access network 15 may be another such piece of equipment (e.g. a printer). Further, the downlink signal is, in such an embodiment, the signal from the other piece of equipment.

The invention is described above in terms of a method (and also in terms of a UE and a radio access network). Besides a method, the invention also encompasses a corresponding computer program product including a computer readable storage structure embodying computer program code—i.e. software or firmware—thereon for execution by a computer processor.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

1. A method for use in communication at a downlink frequency between a wireless communication terminal, having a plurality of radio receiver branches, and a radio access network or other wireless communication terminal, comprising:
a step in which the wireless communication terminal tunes at least one of the plurality of radio receiver branches to a non-downlink frequency and so begins operating in a reduced performance mode; and
a step of retuning the at least one radio receiver branch to the downlink frequency;
wherein the wireless communication terminal signals or otherwise indicates to the radio access network or other wireless communication terminal intermittent use of the reduced performance mode.

2. A method as in claim 1, further comprising:
a step in which the wireless communication terminal signals to the radio access network or other wireless communication terminal an indication that the wireless communication terminal uses the reduced performance mode in order to receive the non-downlink frequency.

3. A method as in claim 1, further comprising:
a step in which the radio access network or other wireless communication terminal receives from the wireless communication terminal an indication that the wireless communication terminal uses the reduced performance mode in order to receive the non-downlink frequency.

4. A method as in claim 1, further comprising:
a step in which the radio access network or other wireless communication terminal compensates for use of the reduced performance mode by using increased downlink power or by using a more robust radio link during at least some time periods when the wireless communication terminal is expected to use the reduced performance mode.

5. A method as in claim 1, further comprising:
a step in which the radio access network or other wireless communication terminal signals to the wireless communication terminal an indication of an allowed time period when the wireless communication terminal is authorized to use the reduced performance mode.

6. A computer program product comprising: a computer readable storage structure embodying computer program code thereon for execution by a computer processor in a wireless communication terminal having a plurality of radio receiver branches ordinarily all used to receive a downlink frequency from a radio access network or other wireless communication terminal, with said computer program code characterized in that it includes instructions for performing a method comprising:
a step in which the wireless communication terminal signals to the radio access network or other wireless communication terminal an indication that the wireless communication terminal may use a reduced performance mode in order to receive a non-downlink frequency; and
a step in which the wireless communication terminal tunes at least one of the plurality of radio receiver branches to the non-downlink frequency and so begins operating in the reduced performance mode.

7. A computer program product comprising: a computer readable storage structure embodying computer program code thereon for execution by a computer processor in a component of a radio access network or a downlinking wireless communication terminal configured for providing a downlink signal on a downlink frequency to a wireless communication terminal having a plurality of radio receiver branches ordinarily all used to receive the downlink frequency, with said computer program code characterized in that it includes instructions for performing a method comprising:
a step in which the radio access network or downlinking wireless communication terminal receives from the wireless communication terminal an indication that the wireless communication terminal uses a reduced performance mode in order to receive a non-downlink frequency; and
a step in which the radio access network or downlinking wireless communication terminal compensates for use of the reduced performance mode by using increased downlink power or by using a more robust radio link during a time period when the wireless communication terminal is using the reduced performance mode.

8. A wireless communication terminal, comprising:
a plurality of radio receiver branches; and
a controller, for tuning the radio receiver branches to a downlink frequency for receiving a downlink signal from a radio access network or other wireless communication terminal;
wherein in order to also receive a non-downlink frequency, the controller tunes at least one of the radio receiver branches to the non-downlink frequency and so receives the downlink frequency in a reduced performance mode, and further wherein the wireless communication terminal signals or otherwise indicates to the radio access network or other wireless communication terminal intermittent use of the reduced performance mode.

9. A wireless communication terminal as in claim 8, further comprising:
means for signalling to the radio access network or other wireless communication terminal an indication that the wireless communication terminal uses the reduced performance mode in order to receive the non-downlink frequency.

10. A wireless communication terminal as in claim 8, further comprising:
means for compensating for the use of the reduced performance mode.

11. A wireless communication terminal as in claim 10, wherein the means for compensating for the use of the reduced performance mode is based on a request for increased downlink power.

12. A wireless communication terminal as in claim 10, wherein the means for compensating for the use of the reduced performance mode is based on using a channel quality indicator report to indicate a lower channel quality.

13. A wireless communication terminal as in claim 8, further comprising:
means for receiving from the radio access network or other wireless communication terminal an indication of an allowed time period when the wireless communication terminal is authorized to use the reduced performance mode;
and wherein the controller tunes the at least one radio receiver branch to the non-downlink frequency only during the allowed time period.

14. A wireless communication terminal as in claim 8, wherein the controller tunes the at least one radio receiver branch to the non-downlink frequency at a time decided on autonomously by the wireless communication terminal.

15. A wireless communication terminal as in claim 14, wherein the controller tunes the at least one radio receiver branch to the non-downlink frequency at a time based on observed received signal quality.

16. A wireless communication terminal as in claim 8, wherein the non-downlink frequency is a frequency associated with inter-frequency or inter-radio-access-technology measurements.

17. A wireless communication terminal as in claim 8, wherein the non-downlink frequency is a frequency used for location measurements.

18. A wireless communication terminal as in claim 8, wherein the non-downlink frequency is any frequency, including another downlink frequency, other than the downlink frequency to which the other radio receiver branches are tuned.

19. A radio access network, comprising:
means for receiving from a wireless communication terminal an indication that the wireless communication terminal uses a reduced performance mode in receiving a downlink frequency from the radio access network or other wireless communication terminal in order to also receive a non-downlink frequency; and
means for determining when the wireless communication terminal is using or is authorized to use the reduced performance mode.

20. A radio access network as in claim 19, further comprising:
means for accommodating the reduced performance mode by using increased downlink power or by using a more robust radio link during at least some time periods when the wireless communication terminal is expected to use the reduced performance mode.

21. A radio access network as in claim 19, further comprising:
means for signaling to the wireless communication terminal an indication of an allowed time period when the wireless communication terminal is authorized to use the reduced performance mode.

22. A wireless communication network including a radio access network as in claim 19, and including a wireless communication terminal configured for wireless communication with the wireless communication network via the radio access network and comprising:
a plurality of radio receiver branches; and
a controller, for tuning the radio receiver branches to a downlink frequency for receiving a downlink signal from a radio access network or other wireless communication terminal;
wherein in order to also receive a non-downlink frequency, the controller tunes at least one of the radio receiver branches to the non-downlink frequency and so receives the downlink frequency in a reduced performance mode, and further wherein the wireless communication terminal signals or otherwise indicates to the radio access network or other wireless communication terminal intermittent use of the reduced performance mode.

23. A wireless communication network as in claim 22, wherein the wireless communication network is a cellular communication network.

24. A wireless communication network as in claim 22, wherein the wireless communication terminal is a mobile communication terminal.
